(19) United States
(12) Patent Application Publication
(10) Pub. No.: US 2007/0101338 A1
(43) Pub. Date: May 3, 2007

(54) Detection, diagnosis and resolution of deadlocks and hangs

(75) Inventors: Abdelsalam A. Heddaya, Bellevue, WA (US); Stephan A. Doll, Seattle, WA (US); Bradley M. Waters, Woodinville, WA (US); William R. Barnes, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/263,318

(22) Filed: Oct. 31, 2005

(51) Int. Cl. G06F 9/46

(52) U.S. Cl. 718/104

(57) ABSTRACT

A computer configured for managing multiple processing threads is susceptible to deadlocks or hangs when resources needed by one process are locked by another process that is not progressing. Locking relationships are created and released so quickly that rigidly monitoring these relationships would consume more computer power than are being monitored. An approach to determining the existence of a deadlock or hang uses a first ‘snapshot’ showing an approximation of locking relationships and then verifies a deadlock or hang using a second snapshot to determine if a suspected deadlock or hang is still present.

### BACKGROUND

Operating systems are a key building block in the development of computing systems. Over the several decades since personal computing has become widespread, operating systems have substantially increased in complexity. The ability to multi-task and support concurrent processes has given even modest personal computers the appearance of simultaneously running a wide variety of programs from word processors to Internet browsers.

In fact, though, virtually all microprocessor-based systems run one program at a time, using a scheduler to guarantee that each running program is given processor time in sufficient quantities to keep running. This task can become quite complex. Each process running on a computer can spawn individual tasks called threads. Some threads can spawn subordinate threads. It is common to have dozens, or even hundreds, of threads active at a given time. On the other hand, the computer may have a limited number of resources, such as disk storage or network input/output. Even though each resource can often support multiple threads, in many cases a thread may have to wait for access to a given resource until a different thread releases it.

A thread can lock a resource it is using and make it unavailable for other threads. A common situation occurs where two or more threads require resources that are locked by another thread. When threads lock each other's resources a deadlock may occur. Typically, a timeout timer will fire when inactivity is observed over a pre-determined time period and kill one or more of the involved threads. Unfortunately, most users are less patient than the timers and will intervene before the timeout period with a reset or other dramatic action. The timeout time can be shortened to beat user's impatience but at the risk of killing slow but not-deadlocked threads.

Another way to address deadlocks is strict monitoring of every locking relationship. However, in modern high-clock rate systems, locks can be placed and released in a matter of microseconds and it is not unusual for hundreds of locks to exist at any moment in time. Therefore, strict monitoring may require more processor resources than those being monitored and the associated memory write times could slow processing to a crawl.

### SUMMARY

An operating system may monitor and verify deadlock conditions by taking advantage of the fact that, by definition, deadlocks are persistent. A quick scan of locking relationships may be made, building an approximation of locks and dependencies. It is an approximation because even several clock cycles after scanning the locking relationships, those relationships are obsolete. Even between the beginning of the scan and the end, the relationships may change. An analysis of the scan of locking relationships may show cyclical relationship as described above, but in fact, it may not be cycle, only an artifact of a locking relationship that no longer exists.

However, a real deadlock may exist. By examining the locking relationships a second time, particularly targeting suspect locking relationships of the first scan, a deadlock can be verified because it will persist over extended periods of time. When a deadlock is confirmed, data corresponding to the threads and resources involved can be forwarded to a monitor or other process that can intervene to break the deadlock, preferably before a user notices the incident.

Although not a deadlock by definition, a similar situation called a hang, where a thread or resource stops or becomes inaccessible and blocks predecessors with locking relationships can be monitored and verified in a similar fashion. Determining hangs can be useful for both resolving the hang and diagnosing root causes for the situation.

### BRIEF DESCRIPTION OF THE DRAWINGS

FIG. 1 is a simplified and representative block diagram of a computer;

FIG. 2 is a block diagram showing a wait-chain relationship in a computer; and

FIG. 3 is a flow chart depicting a method of determining a deadlock or hang in a computer.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

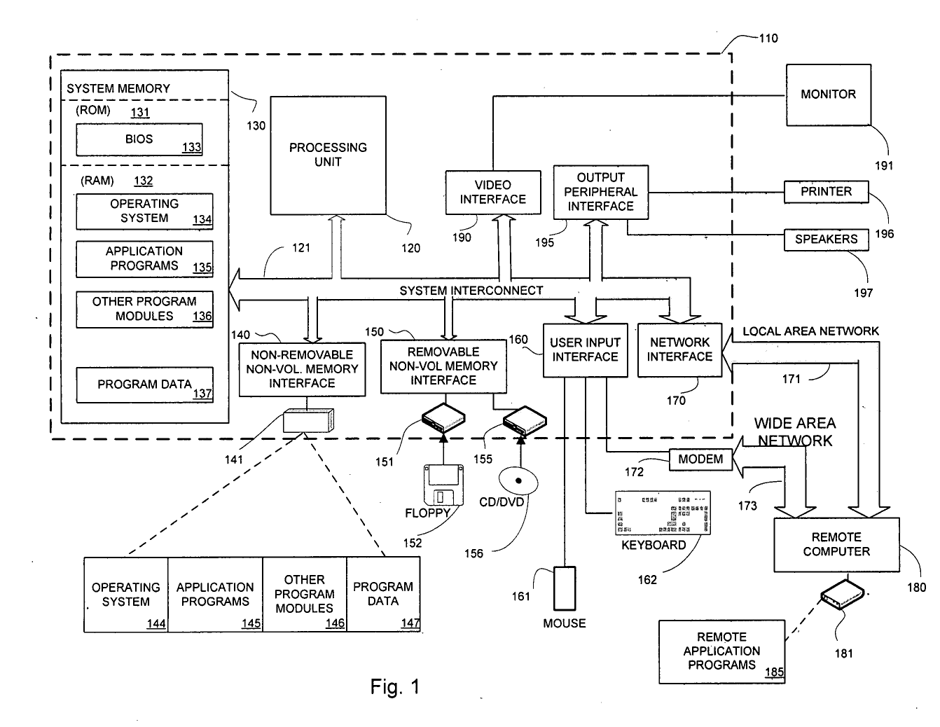

FIG. 1 illustrates a computing device in the form of a computer 110. Components of the computer 110 may include, but are not limited to a processing unit 120, a system memory 130, and a system interconnect 121 that couples various system components including the system memory to the processing unit 120. The system interconnect 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system interconnect 121 through a non-removable memory interface such as interface 140, and magnetic disk drive 151 and optical disk drive 155 are typically connected to the system interconnect 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system interconnect, but may be connected by other interface and bus structures, such as a parallel port, game port or a universal serial bus (USB). A monitor 191 or other type of display device is also connected to the system interconnect 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system interconnect 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

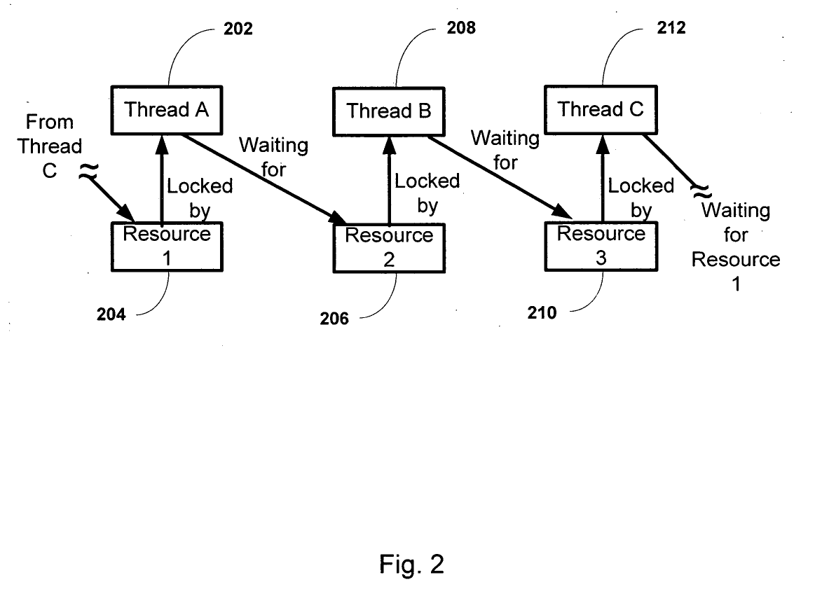

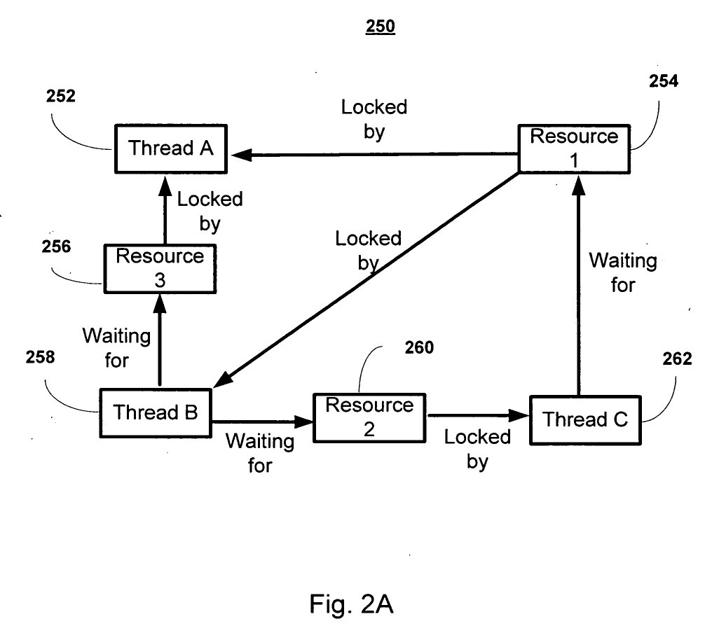

FIG. 2 is a block diagram showing a wait-chain relationship illustrating a condition in a computer known as a deadlock. Thread A 202 owns the lock on Resource 1 204, Thread A 202 is also waiting for Resource 2 206. Thread A 202 cannot access Resource 2 206 because it is locked by Thread B 208. In turn, Thread B 208 is waiting for Resource 3 210. Resource 3 210 is locked by Thread C 212. To this point, this is not necessarily a problem. If Thread C 212 releases Resource 3 210, the dependencies will clear. However, if Thread C 212 is waiting for Resource 1 204, a deadlock exists and the processing associated with each of the three threads 202 208 212 will stop. This is one form of blockage caused by a wait-chain among resources and threads.

A related situation, a hang, may occur when one thread, for example, Thread C 212, may not be waiting for another resource, but instead is slow or stopped. All the preceding elements (threads 202, 208 and resources 204, 206) will be blocked until Thread C 112 releases Resource 3 210. It is not just threads that can cause hangs, but also resources. For example, if Resource 3 210 is a network connection, it may itself be too slow or unable to make progress, even though its owner, Thread C 212 is active and making progress. A third related wait-chain relationship is an orphaned resource, which occurs when one thread, for example, Thread C 212, is simply non-existent, either because it terminated or was killed. A chain that contains an orphaned resource also represents a hang, because all the threads that are waiting for the orphaned resource to be released are prevented indefinitely from making progress.

The resources of FIG. 2 may be those traditionally thought of a resources, such as, memory locations, print queues, database queues, etc. However, with respect to their ability to play in wait-chain relationships, other functions may also fall into the category of resources that are atypical. For example, a remote procedure call (RPC) may cause the caller thread to wait until the callee thread returns the result. In this case, we say that the RPC is owned by the callee thread. When the result is slow in coming or lost, the RPC may be part of a wait-chain that represents a hang, as discussed above. Other kinds of response-oriented operations, such as acquiring locks or semaphores, waiting for network or I/O connections, or sending a message and waiting for the receiver to process it, may also act in this manner.

As well, the threads and resources involved in a wait-chain are not necessarily restricted to one-to-one relationships. As shown in FIG. 2A, a thread can wait for multiple resources and a resource can be owned by multiple threads. In FIG. 2A, a graph 250 of threads and resources shows Thread A 250 owns Resource 1 254. Thread B 258 is waiting for Resource 2 and Resource 3. Resource 3 owned by Thread A 250. In the other branch of the graph, Thread B 258 is waiting for Resource 2 260 and owns Resource 1 254. Resource 2 260 is owned by Thread C 262. The deadlock cycle is completed by Thread C 262 waiting for Resource 1. Even in the presence branches or multiple dependencies, the techniques for identifying and verifying deadlocks, hangs, and orphans still apply.

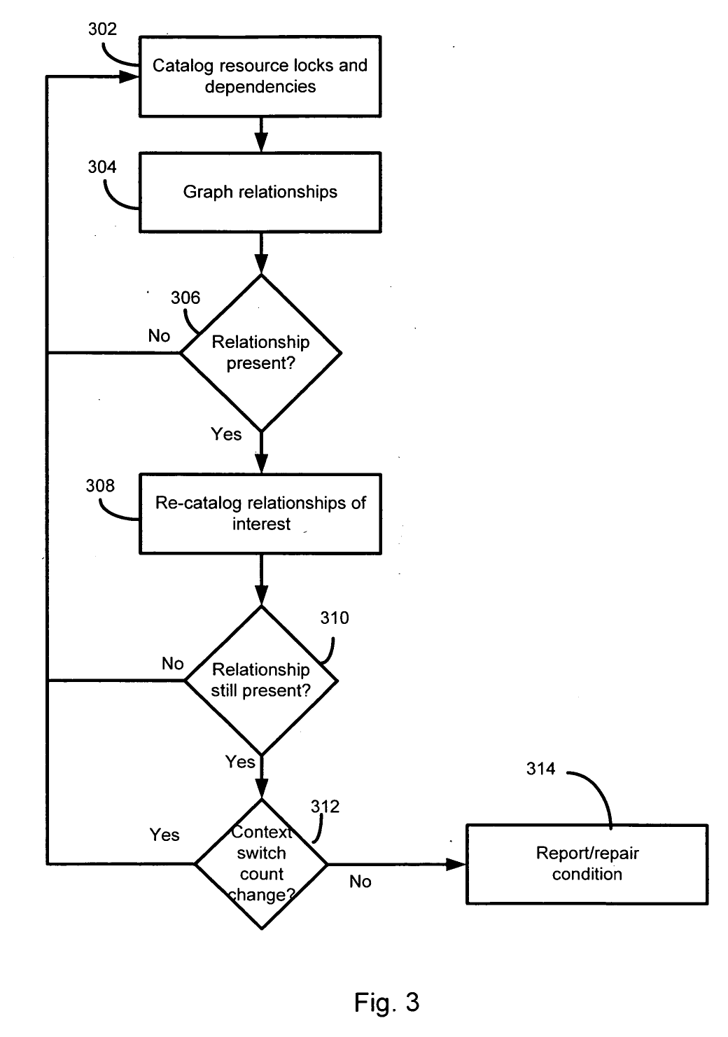

FIG. 3, a method of determining a deadlock or hang in a computer, is discussed and described. At block 302, a process running on a computer 110 may catalog or enumerate threads waiting for a resource as well as resources being locked or owned by threads. A graph of these relationships may be made at block 304. The graph may be a list, data structure, or other representation of the data. The graph may include unique identification of the thread, such as a thread handle. Thread data may also include a context switch count, indicative of the state of processing of the thread. In one embodiment, the cataloging of threads waiting for a resource and resources locked or committed to threads may be done a synchronously to other processes operating with the memory where the resource dependency data is stored. That is, cataloging may occur at the same time other processing is in progress and may also occur with the same or lower priority. This is in contrast to known methods of stopping all processes while a deterministic analysis of wait-chain relationships is performed. This synchronous method of looking for wait-chains is inefficient at best and in some cases may cause fatal timing problems in the halted processes.

The relationship data may be analyzed to determine if a potential wait-chain relationship exists at block 306. For example, a potential wait-chain relationship may be a cycle, that is, a combination of threads waiting for resources and resources waiting for ownership, such as lock, held by threads that loops back on itself, as shown in FIG. 2, in other words, a deadlock. Another wait-chain relationship may be a hang, as exemplified by a series of events that persist over a period of time with a common terminal point, the source of the hang. A hang is different from a deadlock in that a deadlock having a cycle will never clear without outside intervention while a hang may be dependent on an extremely slow resource such as that available over a network. The hang may clear itself when the slow resource finally completes its task and returns data or sends an error. Another wait-chain relationship that can cause processing failure is a non-existent thread, that is, a thread in a wait-chain relationship that has been killed or otherwise stopped. The surrounding threads and resources may be held by a thread that simply no longer exists. When no wait-chain relationship is identified, the no branch from block 306 may be taken to block 302 and the process started over, in some cases after a delay period. If a wait-chain relationship is found, the yes branch from block 306 may be taken to block 308. At block 308, data corresponding to locked resources and threads may again be gathered. While a complete catalog, similar to the first, may be taken, it may be more efficient to only catalog the elements identified as being of interest at block 306. At block 410 the data may be analyzed to determine if the wait-chain relationship identified at block 406 still exists, and the threads in the wait chain have not made progress. Depending on how the data was collected an exhaustive search may be required. If only data of interest is cataloged it may be quicker to compare only the elements of interest to the prior list. In one embodiment, a way to verify that threads have not made progress is to check the context switch count that the operating system increments every time a thread runs on a processor. In an alternative embodiment, the cataloging at block 408 may be done in the reverse order of thread appearance at block 402 starting from a thread that can be frozen (prevented from making progress) for the duration of the verification step. This can be done by requesting the OS to freeze the thread temporarily, or by having the thread in question itself run the verification step, since while it is running that step, it cannot do anything else, including releasing a locked resource. Matching in this fashion is especially valuable in verifying wait-chains in situations where a context switch count may not be available. This method works because threads on a wait-chain that is verified in the opposite order of the waiting relationship are guaranteed not to have made progress. Because each of the resources being analyzed may be more quickly identified as not having changed between measurements, this method may allow easier verification of a deadlock or hang.

If the context switch count has changed and the change is not attributable to the analysis process, then the Yes branch from block 312 may be followed to block 302. When there are no changes in context switch count except those that can be accounted for, then the No branch from block 312 may be followed to block 314.

At block 314, information about the threads involved in the wait-chain relationship may be reported to a monitor or other process capable of breaking the deadlock. To break the deadlock a number of methods may be used, including killing one of the threads. Another method may be to force an error from the resource that causes the thread to release the lock. By enabling an error to be returned, other processes involved may be able to recover both more quickly and with fewer side effects than the more dramatic technique of simply killing the offending process.

Another application of this technique may be applied to preventing deadlocks from occurring in the first place. When a thread is about to place a lock, the two-step cataloging process may be initiated to see if the proposed new wait-chain relationship will introduce a deadlock.

As mentioned above, resource locks may be placed and released hundreds at a time and last as short as microseconds. By taking advantage of the persistent nature of a deadlock or hang, the need to exhaustively catalog every resource lock, particularly in real-time, may be eliminated. Thread dependencies and resource ownerships may be cataloged and analyzed on an intermittent basis over a relatively long periods of time, for example, a second or more. Deadlocks and hangs may be positively identified in the second measurement step simply by comparing the second measurement data to the approximation of resource ownerships and thread dependencies of earlier measurement. In contrast to a timeout scheme, this method may allow the identification and resolution of the deadlock before a user is aware of any problem.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer comprising:
a processor; and
a memory storing instructions executable by the processor, the instructions for implementing a method comprising:
cataloging a first set of data corresponding to dependency relationships between threads and resources;
identifying a potential wait-chain relationship between the threads and resources of the first set of data;
cataloging a second set of data including those threads and resources of the first set of data determined to have the potential wait-chain relationship; and
confirming that the potential wait-chain relationship is an actual wait-chain relationship by verifying that threads corresponding to the potential wait-chain relationship have not progressed.

2. The computer of claim 1, wherein the memory further stores instructions for resolving the actual wait-chain relationship.

3. The computer of claim 1, wherein the memory further stores instructions for building a graph of resource ownership and thread dependencies to identify a cycle of resource ownership and thread dependencies resulting in a deadlock.

4. The computer of claim 1, wherein the memory further stores instructions for determining when the wait-chain relationship is a hang by identifying a chain of threads waiting on one of a non-responsive resource or a non-responsive thread.

5. The computer of claim 1, wherein the memory further stores instructions for determining when the wait-chain relationship is orphaned by identifying a chain of threads and resources waiting on a non-existent thread.

6. The method of claim 1, wherein identifying a potential wait-chain relationship comprises matching threads waiting for access to resources with resource ownership to determine the wait-chain relationship.

7. The method of claim 1, wherein cataloging the first set of data corresponding to dependency relationships between resources and threads further comprises gathering an approximation of the dependency relationships by observing resource and thread relationships over an interval.

8. A method of determining resource blockages causing an undesired state in a computer comprising:
cataloging first data corresponding to resource ownership and thread dependency at a first time;
determining when the first data has a characteristic indicative of the undesired state;
cataloging second data corresponding to resource ownership and thread dependency at a second time; and
confirming the characteristic by comparing elements of the second data to corresponding elements of the first data.

9. The method of claim 8, wherein the undesired state is a wait-chain with a dependency on a non-existent thread.

10. The method of claim 8, wherein the undesired state is a suspected deadlock.

11. The method of claim 8, wherein the undesired state is a suspected hang.

12. The method of claim 8, wherein the cataloging the first data and cataloging the second data occur at different times and are asynchronous to other computing processes.

13. The method of claim 8, wherein cataloging thread dependency comprises storing thread data, the thread data including a resource the thread is waiting on and a context switch count associated with the thread.

14. The method of claim 13, wherein confirming the characteristic comprises determining that a cycle exists and that the context switch count associated with the thread has remained constant within accountable limits.

15. The method of claim 8, wherein cataloging resource ownership comprises storing an identifier corresponding to a first thread holding a resource.

16. A computer-readable media storing computer-executable instructions for implementing a method of identifying a deadlock in a computer system, the method comprising:
indexing thread resource ownership data and resource dependency data;
analyzing the thread resource ownership data and resource dependency data to determine when a set of resource dependencies form a cycle;
re-indexing the thread resource ownership data and resource dependency data corresponding to the set of resource dependencies forming the cycle; and
confirming the cycle as the deadlock by analyzing changes between the indexing and re-indexing in thread context switch count data associated with the resource dependency data.

17. The computer-readable medium of claim 16, further comprising computer-executable instructions implementing the method further comprising resolving the deadlock by causing at least one thread in the cycle to return an error.

18. The computer-readable medium of claim 16, wherein confirming the cycle by analyzing thread data comprises determining when the threads involved in the cycle have not made progress.

19. The computer-readable medium of claim 16, wherein the indexing and the re-indexing is performed prior to a thread establishing ownership of a resource to determine if a deadlock will result.

20. The computer-readable medium of claim 16, wherein re-indexing the thread resource ownership data and resource dependency data comprises gathering the resource ownership data and resource dependency data in the reverse order of their appearance from the original indexing of resource lock data and resource dependency data.
